(19) United States
(12) Patent Application Publication
(10) Pub. No.: US 2007/0092660 A1
(43) Pub. Date: Apr. 26, 2007

(54) Method and device for forming wiring

(75) Inventors: In-Keun Shim, Seoul (KR); Jae-Woo Joung, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/581,364

(22) Filed: Oct. 17, 2006

(30) Foreign Application Priority Data
Oct. 17, 2005 (KR) 10-2005-0097647

(51) Int. Cl. B05D 3/02; B05D 5/12; B22D 39/00; B05D 1/32

(52) U.S. Cl. 427/466; 222/590; 427/372.2; 427/123; 428/901; 118/300; 118/629

(57) ABSTRACT

The present invention provides the method for forming a fine wiring quickly by using magnetic ink. Also the present invention provides wiring forming method and device by which the coffee stain and the migration are not caused due to the ink with the uniformly dispersed metal nanoparticles so that the wiring with distinguished electrical reliability is obtained. Also the present invention provides a substrate with excellent electrical conductivity and reliability. According to an aspect of the present invention, a wiring forming method to apply a magnetic field on the magnetic ink may be provided in a step of forming a wiring by ejecting magnetic ink on one side of a substrate.

### CROSS-REFERENCE TO RELATED APPLICATIONS

This application claims the benefit of Korean Patent Application No. 10-2005-0097647 filed on Oct. 17, 2005 with the Korean Intellectual Property Office, the contents of which are incorporated here by reference in their entirety.

### BACKGROUND

1. Technical Field

The present invention relates to a method and device for forming a wiring and more especially, to a method and device to form a fine wiring.

2. Description of the Related Art

A method for forming a fine wiring on a substrate by an ink-jet method has been introduced recently. This method can produce a fine wiring selectively, so that it provides merits in saving time and costs by simplifying a process. In the meantime, needs for a fine wiring is increasing in response to demands for electronic devices with smaller sizes. But there is a problem with resolution of printing techniques by this method, so that the size of the wiring and the width between the wirings do not meet the needs of light weight and small size. The resolution is determined by a diameter, a surface tension and an inter-facial tension of the ink. Metal nanoparticles must be included in the droplet to form a conductive wiring, so that there is a limit of reducing the ink-jet head size and the ejected droplet diameter.

In addition when the ink is ejected by the ink-jet method, poor spread of the ink on a substrate hinders forming a fine wiring. The degree of spread depends on an ink ejection speed, a viscosity of the ink, an ink drying speed, a weight ratio of the metal particles in the ink and a surface property of a substrate. In addition when ink droplets dry, the transmissible flow caused by the difference of the ink droplet drying speed makes metal nanoparticles move to the edge of the droplet, so that a phenomenon of coffee stain occurs. The coffee stain decreases an electrical conductivity and causes a migration of the metal, so that it eventually deteriorates the reliability of products.

So a variety of efforts by the ink-jet method are made to form a fine pattern and to produce a wiring with an excellent electrical reliability.

### SUMMARY

As a solution to the forgoing problems of prior art, the present invention provides a method for forming rapidly a fine wiring by using magnetic ink.

The present invention provides a wiring forming method with a good electrical reliability that allows a uniform distribution of metal nanoparticles in an ink droplet, so that it prevents coffee stain or migration.

The present invention also provides a fine wiring forming device with rapidity by using magnetic ink.

The present invention also provides a wiring forming device which shows distinguished electrical reliability without generating the coffee stain and the migration.

The present invention also provides a substrate with distinguished electrical conductivity and reliability.

Additional aspects and advantages of the present general inventive concept will be set forth in part in the description which follows and, in part, will be obvious from the description, or may be learned by practice of the general inventive concept.

One aspect of the present invention may provide a method for forming a wiring comprising, (a) forming a wiring by ejecting magnetic ink on one side of a substrate with a magnetic field applied on the magnetic ink; and (b) curing the formed wiring.

Here, the magnetic field may be generated by a magnetic field generating unit located at the other side of the substrate in correspondence with a position where the magnetic ink is ejected and the magnetic field generating unit may be moved in correspondence with the movement of an ink-jet head which ejects the magnetic ink.

According to an embodiment of the present invention, the magnetic field generating unit may comprise a plurality of magnetic field sources.

Another embodiment of the present invention may provide a method for forming a wiring comprising, (a) forming the wiring by ejecting magnetic ink on one side of a substrate with a magnetic field applied on the magnetic ink; and (b) curing the formed wiring with a magnetic field applied on the formed wiring.

Here the magnetic field may be generated by a magnetic field generating unit at the other side of the substrate, which comprises an ink magnetic field generating unit which is located in correspondence with a portion where the magnetic ink is ejected; and a wiring magnetic field generating unit which is located in correspondence with the formed wiring. Here the step (b) may be performed by a curing unit which is located at the other side of the substrate.

According to one embodiment of the present invention, the wiring magnetic field generating unit may be positioned to be entirely or partially overlapped with the curing unit. Also the ink magnetic field generating unit may move in correspondence with the movement of an ink-jet head which ejects the magnetic ink, and the wiring magnetic field generating unit may move in correspondence with the movement of the formed wiring.

According to another embodiment of the present invention, the ink magnetic generating unit and the wiring magnetic field generating unit may comprise a plurality of magnetic field sources, respectively, and each of these plurality of magnetic field sources may move independently in correspondence with different movement control signals.

Here the magnetic field sources may comprise a magnet or a source of electricity and a coil which generates a magnetic field with electric current supplied by the source of electricity. Here the magnetic field may be applied parallel with the ejecting direction of the magnetic ink and the magnetic ink may comprise at least one metal nanoparticle selected from the group consisting of Fe, Co, Ni, Mn, and an alloy thereof.

Another aspect of the present invention may provide a substrate comprising a wiring produced by the method for forming a wiring

Another aspect of the present invention may provide a device for forming a wiring comprising an ink-jet head which ejects magnetic ink on one side of a substrate; and a magnetic field generating unit located at the other side of the substrate in correspondence with the ink-jet head, and configured to generate a magnetic field on the magnetic ink when the magnetic ink is ejected to form a wiring.

Here the device for forming the wiring may further comprise a curing unit configured to heat the formed wiring, and according to one embodiment of the present invention, the curing unit may be located at the other side of the substrate.

Here the magnetic field generating unit may be positioned not to overlap with the curing unit or positioned entirely or partially to overlap with the curing unit so that the magnetic field may be generated on the formed wiring for curing.

Here the magnetic field generating unit may move in correspondence with the movement of the ink-jet head and may comprise a plurality of magnetic field sources.

According to another embodiment of the present invention, each of the plurality of magnetic field sources may move independently in correspondence with different movement control signals, may comprise a magnet, or a source of electricity and a coil which generates a magnetic field by being supplied electric current from the source of electricity.

Here the magnetic field may be applied parallel to an ejecting direction of the magnetic ink, and the magnetic ink may comprise at least one metal nanoparticle selected from the group consisting of Fe, Co, Ni, Mn and an alloy thereof.

### BRIEF DESCRIPTION OF THE DRAWINGS

FIG. 1 illustrates an ink droplet ejected on a substrate according to a conventional technique.

FIG. 2 is illustrates an ink droplet ejected on a substrate according to an embodiment of the present invention.

FIG. 3 illustrates a method for forming a wiring according to an embodiment of the present invention.

FIG. 4 illustrates a method for forming a wiring according to another embodiment of the present invention.

FIG. 5 illustrates a device for forming a wiring according to an embodiment of the present invention.

FIG. 6 illustrates a device forming a wiring according to another embodiment of the present invention.

### DETAILED DESCRIPTION

Hereinafter, preferable embodiments of the wiring forming method and device of the present invention will be explained in detail with reference to the accompanying drawings. The phenomena which may occur in the ejected ink will first be explained before the preferred embodiments are described in detail.

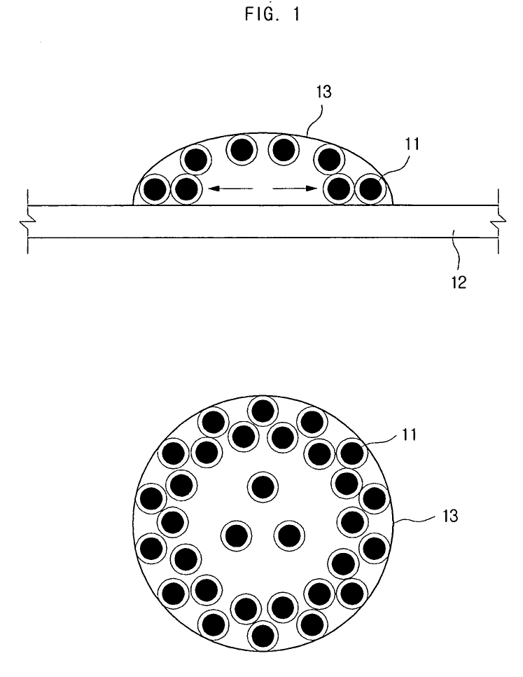

FIG. 1 illustrates an ink droplet ejected on a substrate according to a conventional technique. FIG. 1 shows a plane view of ink and sectional view of the ink droplet when the ink 13 including metal nanoparticles 11 is ejected on one side of the substrate 12 through a nozzle. The ink droplet 13 begins to dry on the surface of the ink droplet while standing by to finish printing an entire pattern of the wiring or while a continuous latter process is being carried out. Here the center of the ink droplet 13 shows a different drying rate from an edge of that due to a different thickness between center and edge. For example, the thin edge of the ink droplet dries first and the thick center dries latter in the ink droplet with a shape of a half-ellipse.

This causes phenomena of pinning or the coffee stain since metal nanoparticles 11 dispersed in the ink move toward the edge of the ink droplet due to forming a transmissible flow in the inner part of the droplet. This eventually deteriorates electrical flowability of the wiring and electrical reliability of a product when the unevenly dispersed nanoparticles are treated by a curing process.

The metal nanoparticles are concentrated at the position between the ink droplets or at the inner part of a formed wiring unit, which causes a migration that the metal is precipitated at a cathode with ionization of the metal. The migration not only decreases the electrical reliability of products but also increases defect rate.

The present invention provides a wiring forming method and device which give a uniform distribution of metal nanoparticles in the ink without generating coffee stains and migration by employing a magnetic field.

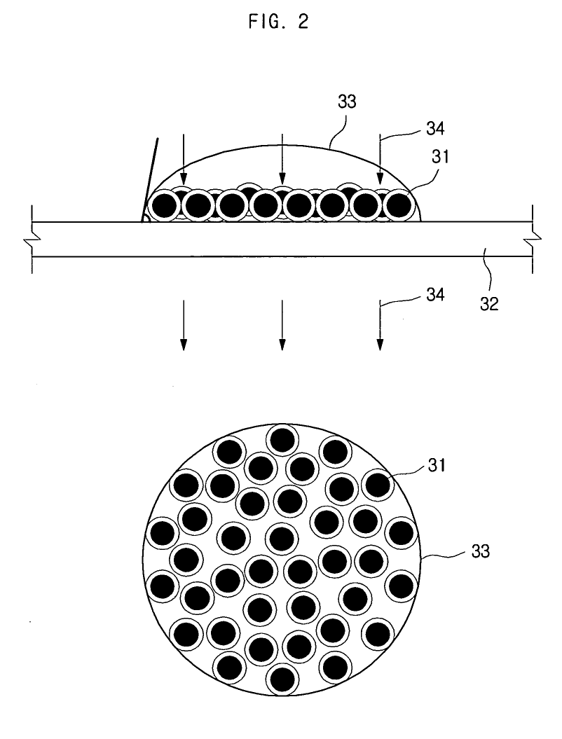

FIG. 2 illustrates an ink droplet ejected on a substrate according to an embodiment of the present invention. FIG. 2 shows that magnetic field 34 is generated in the ejecting direction of the ink when a wiring on a substrate 32 is formed by the use of magnetic ink 33. In this case, metal nanoparticles 31 dispersed in the ink 33 move toward the bottom of the ink droplet (to the substrate direction) and is uniformly distributed in the center and edge of the droplet. Thus, the metal nanoparticles 31 dose not move through the transmissible flow due to the magnetic filed, so that a problem such as coffee stains does not occur even when the surface of the ink droplet is dried. It is preferable that the magnetic field be applied on the ink till the ink 33 is cured, and by this method the wiring with a uniform distribution of the metal nanoparticles is obtained. The wiring shows a distinguished electrical conductivity and little migration so that the electrical reliability of them may increase.

In the present invention, magnetic ink is referred to as the ink 31 which may be influenced by a magnetic field. The ink to form a wiring with electrical conductivity comprises metal nanoparticles, and any ink may be used if the ink possesses magnetic property. Examples of the metal nanoparticles included in the ink to form a wiring by an ink-jet method include Au, Ag, Cu, Ni, Zn, Pt, Pd, Rh, Ru, Ir, Os, W, Ta, Ti, Al, Co, Fe and an alloy thereof.

Here, the ink comprising at least one selected from the group consisting of Fe, Co, Ni, Mn and an alloy thereof, which has ferromagnetism, is preferable. Also to exhibit a good electrical conductivity, the ink further comprising at least one selected from the group consisting of Ag, Cu, Au, Pt, Al and an alloy thereof, which has a distinguished electrical conductivity, is more preferable.

Core-cell structured nanoparticles comprising a soft magnetic core such as Au and a ferromagnetic cell such as Fe is disclosed in U.S. Pat. No. 6,773,823 filed on Apr. 9, 2001. The ink including the above nanoparticles may preferably be used to form the wiring of the present invention. The ink including core-cell structured metal nanoparticles including a core with ferromagnetism such as Fe and a cell with a distinguished electrical conductivity can also be an embodiment of the present invention. It is also apparent that the present invention is not limited to the embodiments of the ink set forth above.

The present invention provides a wiring forming method and device which produce a fine wiring by improving the spread of the ink employing the magnetic filed and allow a rapid process by increasing an ejecting speed of the ink.

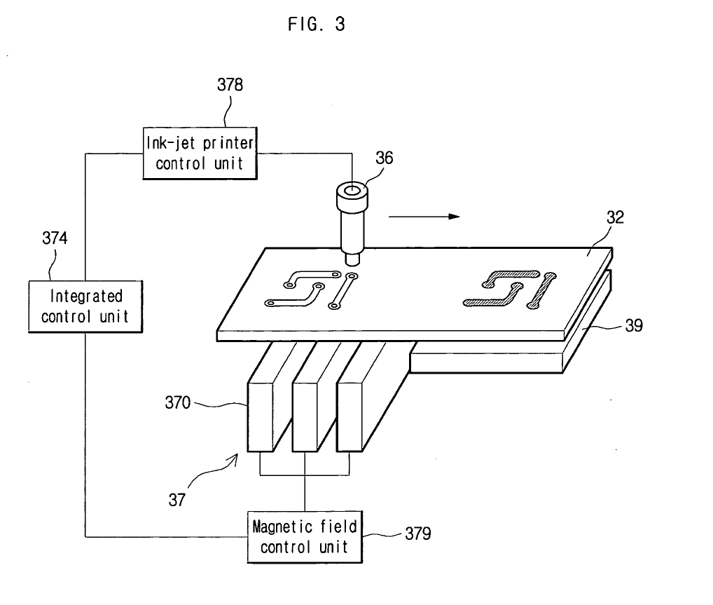

FIG. 3 illustrates a method for forming a wiring according to an embodiment of the present invention. FIG. 3 shows a step for forming a wiring by ejecting the ink 33 on one side of a substrate and a step for curing the substrate. Here, when the ink is ejected to form a wiring on one side of the substrate, the magnetic field is generated to the ink by positioning magnetic field generating unit 37 at the other side of the substrate in correspondence to the position where the ink is ejected. The magnetic generating unit 37 may comprise a plurality of magnetic field sources 370. Here, the magnetic field source is the smallest unit to generate a magnetic field. Therefore, in the case of using a plurality of ink-jet heads to eject the ink, the magnetic field may be applied in correspondence with each ink-jet head. In addition, in the case of using an ink-jet head, the magnetic field to eject the ink, the magnetic field may be applied in correspondence to an ejecting position by using a different magnetic field source.

Here, Curing is carried out by a curing method designed easily by those skilled in the art without departing from the principle and spirit of the present invention and there is no limit about it. According to an embodiment of the present invention, a curing unit 39 is located at the other side of a substrate, namely at the same side to magnetic field generating unit 37, so that it cures the substrate with the formed wiring by moving the substrate to the same plane direction thereof.

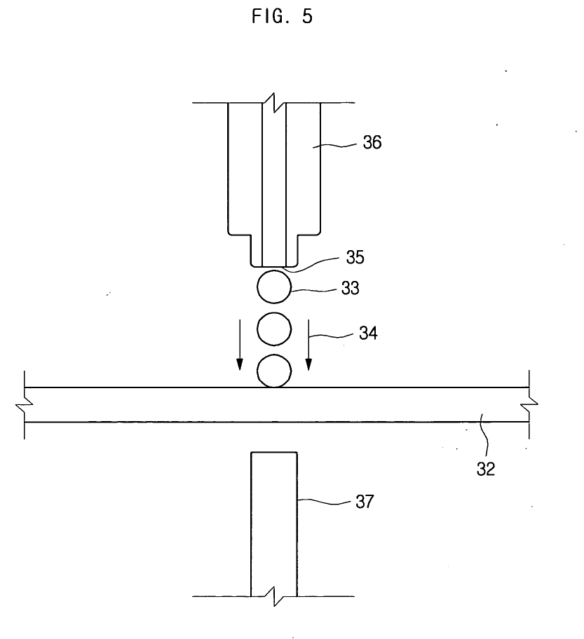

FIG. 5 illustrates a device for forming a wiring according to an embodiment of the present invention. Referring to FIG. 5, the wiring forming device comprises an ink-jet head 36 ejecting an ink 33 on one side of a substrate 32 and a magnetic field generating unit 37 at the other side of the substrate. Although not drawn in FIG. 5, the device for forming a wiring may further comprise a curing unit which cures a wiring-formed substrate. The magnetic field generating unit 37 is positioned in correspondence to the ink-jet head 36, so that it generates a magnetic field on the ink when the ink is ejected to form a wiring.

The ink is ejected with a stronger force than the gravity by the applied magnetic field, so that a printing speed may increase.

The method and device for forming a wiring has been explained above with the drawings which are illustrated generally; hereinafter embodiments for wiring forming method and device of the present invention will be given in a greater detail with specific examples with reference to the accompanying drawings. The method for forming a wiring of the present invention provides two kinds of examples in correspondence with whether the magnetic field is applied on the substrate or not.

Referring to FIG. 3 is illustrated a method for forming a wiring according to an embodiment of the invention, which comprises a magnetic field generating unit 37, to generate a magnetic field on the ink when a wiring is formed by ejecting magnetic ink from an ink-jet head 36, and which does not generate a magnetic field during a curing process. The magnetic field generating unit 37 comprises at least one magnetic field source 370 and a magnetic field control unit 379 which makes the magnetic field source move in correspondence with a movement of the ink-jet head which ejects the magnetic ink. The ink-jet head 36 is controlled by an ink-jet printer control unit 378 programmed to form a wiring in accordance with a desired wiring pattern. The ink-jet printer control unit 378 and the magnetic field control unit 379 configured to control the magnetic field control unit 37 may be controlled by an integrated control unit 374 which is programmed to move in accordance with each other. As mentioned above, at least one magnetic field source 370 moves independently in accordance with different movement control signals and moves in accordance with one or more ink-jet head 34. For example, the magnetic field source comprises a magnet, or a source of electricity and a coil which generates a magnetic field by an electric current provided from the electric source. However the magnetic field source is not limited to such examples set forth above and a variety of magnetic field generating units may be used.

A magnetic field strength provided by the magnetic field generating unit is determined by the magnetic property of the ink such as type, size or content of the metal nanoparticles contained in the ink. However it is also apparent that the present invention is not limited to these examples and a magnetic field generating unit is formed with the magnetic field strength with a range of 10 to 50 gauss, preferably 20 to 30 gauss. This is because if the strength of the magnetic field is within the mentioned range, the ink with straightness can be ejected on the substrate by the ink-jet method. Also the straightness of the ink may be improved by generating a magnetic field parallel to the ejecting direction of the ink.

Also, the size of the magnetic field region generated by the magnetic field generating unit may be equal to or greater than that of the substrate, but it is preferable that the range of the magnetic field strength be determined to be within a range that is advantageous to forming a fine wiring and that does not impose a heavy load on the ink-jet head or other metal constituents due to a magnetic field. For example if the width of a magnetic field is equal to or smaller than that of the wiring, a contact angle between an ink droplet and a substrate increases when the ink is ejected on the substrate, so that a fine wiring may be formed.

Here, the curing is carried out by a curing method designed easily by those skilled in the art without departing from the principle and spirit of the present invention and there is no limit about it.

Curing is demanded to remove organic ingredients in the ink and to bond between metal particles, and a wiring formed with the ink prepared by such processes shows an electrical conductivity. A curing temperature varies with a wiring width or ink ingredients, for examples, additives such as metal nanoparticles, capping molecules, dispersing agents. Also the curing temperature depends on a used substrate such as a substrate with a low melting point like polymeric substrates. The curing may be carried out, but not limited to these, at a temperature range of 120° C. to 350° C. for several seconds to 1 hour, preferably at 200° C. and for 30 minutes.

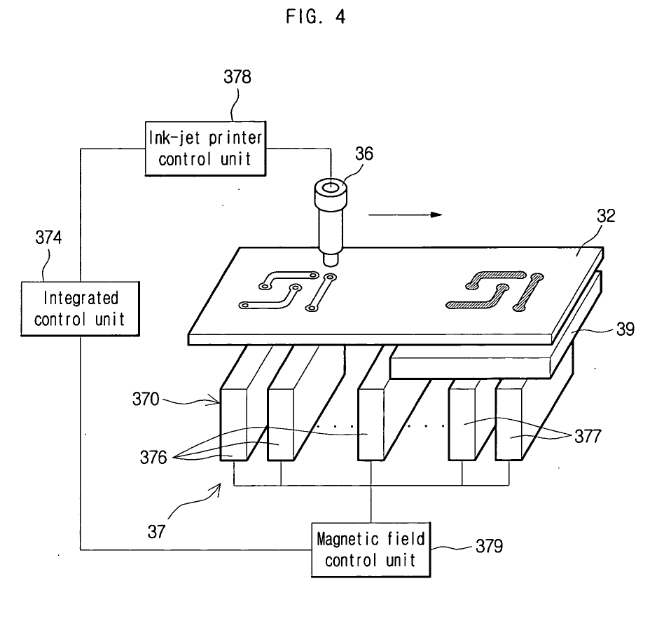

FIG. 4 illustrates a method for forming a wiring according to an embodiment of the present invention. FIG. 4 shows that a magnetic field generating unit 37 is formed to overlap with a curing unit 39. By this method, if a magnetic field is continuously applied not only while drying but also curing the formed wiring with the magnetic ink, it is guaranteed a uniform arrangement of the metal nanoparticles in the ink droplet. Here, the magnetic field is provided by a magnetic field generating unit located at the side of the substrate. The magnetic field generating unit comprises an ink magnetic field generating unit which is located in correspondence to a position where magnetic ink is ejected; and a wiring magnetic field generating unit which is located in correspondence to the formed wiring.

Here, the ink magnetic field generating unit may move in correspondence with a movement of an ink-jet head which ejects the magnetic ink, and the wiring magnetic field generating unit may move in correspondence with a movement of a wiring which is cured. The ink magnetic field generating unit and the wiring magnetic field generating unit independently comprise a plurality of magnetic field sources, respectively, and these magnetic field sources also independently move in correspondence with different movement control signals, and such movements may be controlled by a magnetic field control unit 379 of the magnetic field generating unit. Also the ink-jet head 36 is controlled by a programmed ink-jet printer control unit 378 to form a wiring with a desirable wiring pattern. The ink-jet printer control unit 378 and the magnetic field control unit 379, which controls a magnetic field generating unit 37, may be controlled to move in correspondence with each other by a programmed integrated control unit 374.

The constituents of the magnetic field sources are the same as mentioned above. The wiring magnetic field generating unit may further compose a curing unit between substrates and, to apply a magnetic field on a wiring without disturbing a preferable work of the curing unit, it may generate a magnetic field with different strength from that of the ink magnetic field generating unit.

The curing may be performed with the method which is made by those skilled in the art without departing from the principles and spirit of the present invention. According to an embodiment of the present invention, the curing unit 39 may be located at the other side of the substrate, namely at the same side of the magnetic field generating unit 37, so that it allows the substrate, on which a wiring is formed, to move along the same plane to cure the wiring-formed substrate. At this time, the curing unit may be entirely or partially overlapped with the wiring magnetic field generating unit.

The substrate comprising the wiring produced by the wiring forming method of the present invention may exhibit excellent electrical conductivity and reliability since there is no coffee stain or migration problem. The substrate including the wiring produced by this method may be used as single, double or multi layer substrate and may be used as printed circuit boards or boards for mounting semiconductor.

The method for forming a wiring has been explained with a detailed description above and hereinafter a device for forming a wiring will be described in detail.

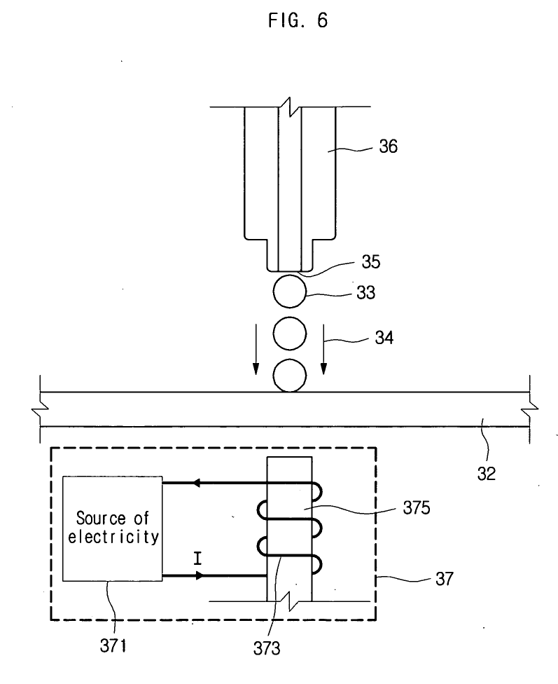

Referring to FIG. 5 and FIG. 6 illustrating a device for forming a wiring according to an embodiment, the device for forming a wiring of the present invention comprises an ink-jet head 36 which ejects the magnetic ink 33 on one side of a substrate 32; and a magnetic field generating unit 37 which is located at the side of the substrate. Also the magnetic field generating unit 37 is faced to the ink-jet head 36 and generates a magnetic field on the magnetic ink 33 when the magnetic ink 33 is ejected.

At this time the magnetic field generating unit may comprise a plurality of magnetic field sources and each of the plurality of magnetic field sources moves independently in correspondence with different movement control signals. The magnetic field source comprises a magnet, or a source of electricity and a coil which generates a magnetic field by being supplied with the electric current from the source of electricity. Referring to FIG. 5, when a magnet 37 is used as a magnetic field generating unit 37 or as a magnetic field source, it is preferable that the magnet be aligned with the ink ejecting direction in order to apply a magnetic field parallel with the ink ejecting direction. Referring to FIG. 6, a coil 373 of the magnetic field generating unit 37 generates a magnetic field on an electromagnet 375 by supplying an electrical current from the source of electricity 371. Here, it is preferable that the applied magnetic field be parallel to the ejecting direction of the ink.

Referring to FIGS. 3 and 4, the device for forming a wiring of the present invention may further comprise a curing unit which heats the formed wiring. The curing unit may be located at the other side of the substrate, namely at the same side of the magnetic field generating unit, but it is not limited to this case, and is located at a different part of the substrate. A variety of applications may be performed by those skilled in the art without departing from the principles and spirit of the present invention. According to one embodiment of the present invention, the magnetic field generating unit may not overlap with the curing unit, and may entirely or partially overlap with the curing unit.

It goes without saying that the magnetic field generating unit, as mentioned above, may be applied to not only a case that it generates a magnetic field on the magnetic ink but also a case that it generates a magnetic field on the formed wiring. At this time, the magnetic field generating unit for a wiring is faced to the formed wiring to move in correspondence with the wiring movement.

The device for forming a wiring by ejecting the ink with the ink-jet method has been described above but in addition it is apparent that the device of the present invention may be applied to a variety of methods for ejecting the ink.

Also, it is apparent that the present invention is not limited to the embodiments set forth above and many of applications may be made by those skilled in the art without departing from the principle and spirit of the present invention, the scope of which is defined in the appended claims and their equivalents.

As described above, the present invention provides the method for forming a fine wiring quickly by using magnetic ink. Also the present invention provides a wiring forming method and device by which the coffee stain and the migration are not caused due to uniformly dispersed metal nanoparticles, so that the wiring with distinguished electrical reliability is obtained. Also the present invention provides a substrate with excellent electrical conductivity and reliability.

What is claimed is:

1. A method for forming a wiring, comprising:
forming a wiring by ejecting magnetic ink on one side of a substrate with a magnetic field applied on the magnetic ink; and
curing the formed wiring.

2. The method of claim 1, wherein the magnetic field is provided by a magnetic field generating unit located at the other side of the substrate in correspondence with a position where the magnetic ink is ejected.

3. The method of claim 2, wherein the magnetic field generating unit moves in correspondence with the movement of an ink-jet head which ejects the magnetic ink.

4. The method of claim 2, wherein the magnetic field generating unit comprises a plurality of magnetic field sources.

5. The method of claim 4, wherein each of the plurality of magnetic field sources moves independently in correspondence with a different movement control signal.

6. The method of claim 4, wherein the magnetic field source comprises a magnet.

7. The method of claim 4, wherein the magnetic field source comprises a source of electricity and a coil which generates a magnetic field with electric current supplied by the source of electricity.

8. The method of claim 1, wherein the magnetic field is applied parallel with the ejecting direction of the magnetic ink.

9. The method of claim 1, wherein the magnetic ink comprises at least one metal nanoparticle selected from the group consisting of Fe, Co, Ni, Mn and an alloy thereof.

10. A substrate comprising a wiring produced by the method of claim 1.

11. A method for forming a wiring, comprising:
forming a wiring by ejecting magnetic ink on one side of a substrate with a magnetic field applied on the magnetic ink; and
curing the formed wiring with a magnetic field applied on the formed wiring.

12. The method of claim 11, wherein the magnetic field is provided by a magnetic field generating unit at the other side of the substrate in which the magnetic field generating unit comprises:
an ink magnetic field generating unit which is located in correspondence with a position where the magnetic ink is ejected; and
a wiring magnetic field generating unit which is located in correspondence with the formed wiring.

13. The method of claim 12, wherein curing is performed by a curing unit which is located at the other side of the substrate.

14. The method of claim 13, wherein the wiring magnetic field generating unit is entirely or partially overlapped with the curing unit.

15. The method of claim 12, wherein the ink magnetic field generating unit moves in correspondence with the movement of an ink-jet head which ejects the magnetic ink.

16. The method of claim 12, wherein the wiring magnetic field generating unit moves in correspondence with the movement of the formed wiring.

17. The method of claim 12, wherein the ink magnetic generating unit and the wiring magnetic field generating unit independently comprise a plurality of magnetic field sources.

18. The method of claim 17, wherein each of the plurality of magnetic field sources moves independently in correspondence with a different movement control signal.

19. The method of claim 17, wherein the magnetic field source comprises a magnet.

20. The method of claim 17, wherein the magnetic field source comprises a source of electricity and a coil which generates a magnetic field with electric current supplied by the source of electricity.

21. The method of claim 11, wherein the magnetic field is applied parallel with the ejecting direction of the magnetic ink.

22. The method of claim 11, wherein the magnetic ink comprises at least one metal nanoparticle selected from the group consisting of Fe, Co, Ni, Mn and an alloy thereof.

23. A substrate comprising a wiring produced by the method of claim 11.

24. A device for forming a wiring, the device comprising:
an ink-jet head which ejects magnetic ink on one side of a substrate; and
a magnetic field generating unit located at the other side of the substrate in correspondence with the ink-jet head, and configured to generate a magnetic field on the magnetic ink when the magnetic ink is ejected to form a wiring.

25. The device of claim 24, further comprising a curing unit configured to heat the formed wiring.

26. The device of claim 25, wherein the curing unit is located at the other side of the substrate.

27. The device of claim 26, wherein the magnetic field generating unit is located not to be overlapped with the curing unit.

28. The device of claim 26, wherein the magnetic field generating unit is located to be entirely or partially overlapped with the curing unit, so that the magnetic field generating unit generates a magnetic field on the formed wiring for curing.

29. The device of claim 24, wherein the magnetic field generating unit moves in correspondence with the movement of the ink-jet head.

30. The device of claim 24, wherein the magnetic field generating unit comprises a plurality of magnetic field sources.

31. The device of claim 30, wherein each the plurality of magnetic field sources moves independently in correspondence with a different movement control signal.

32. The device of claim 30, wherein the magnetic field source comprises a magnet.

33. The device of claim 30, wherein the magnetic field source comprises a source of electricity and a coil which generates a magnetic field when electric current is generated by the source of electricity.

34. The device of claim 24, wherein the magnetic field is applied parallel to an ejecting direction of the magnetic ink.

35. The device of claim 24, wherein the magnetic ink comprises at least one metal nanoparticle selected from the group consisting of Fe, Co, Ni, Mn and an alloy thereof.
